(19) United States
(12) Patent Application Publication
(10) Pub. No.: US 2007/0084025 A1
(43) Pub. Date: Apr. 19, 2007

(54) Grasping device with resilient gripping material

(76) Inventor: John Douglas Sparks, Kamloops (CA)

Correspondence Address: JOHN DOUGLAS SPARKS, 2175 WESTERDALE COURT, KAMLOOPS, BC, V1S 1R7, CA

(21) Appl. No.: 11/237,674

(22) Filed: Sep. 29, 2005

(51) Int. Cl. B42F 1/00

(52) U.S. Cl. 24/535

(57) ABSTRACT

A portable grasping device for gripping door handles, water faucets, toilet seats, toilet flush handles and the like which might be handled by the public and accordingly contaminated by germs is described. The device has two arms, one or both of which bear on their inner surfaces a resilient gripping material which may conform to the shape of an item being handled and which may also provide a gripping friction. The material is thick enough on the arm(s) to be compressed slightly when the device is closed, trapping within the device germs which may be transferred to the surface of the material when the device has been used. The device is releasably lockable into a locked position, and can conveniently be locked and unlocked by one hand of a user, requiring little force to use.

### FIELD OF THE INVENTION

The present invention relates to hand-held devices for grasping and handling things, and more particularly to devices which allow a user to grasp an item with his or her hand while limiting the user's exposure to germs which may be on the surface of the item.

### BACKGROUND OF THE INVENTION

Many people are concerned about contracting illnesses such as colds and flus by contact between themselves and the surfaces of items such as door handles, water faucets, toilet seats, toilet flush handles etc. which might be contaminated by “germs” (bacteria, viruses, fungi, protozoa, etc.). It is frequently necessary to touch and handle such items in public places, and many illnesses are spread in this fashion.

The use of grasping devices to assist in manipulating toilet seats, toilet flush handles, door knobs and such is generally known in the prior art. U.S. Pat. No. 5,619,758 (Burkett), for example, discloses a hand-held toilet seat lifting device. U.S. Pat. No. 4,856,140 (Visco et al.) discloses a sanitary handle cover for door knobs to act as a barrier between the fingers of a person and the possibly contaminated surface of a door handle or toilet flush handle. Other patents such as, for example, U.S. Pat. No. 3,975,043 (Miles) disclose gripping devices for objects one may simply generally not desire to touch with one's bare hands.

Of course, also known in the prior art are locking tongs in which the arms of the tongs can be locked in the closed the position. Examples of locking tongs are those disclosed in U.S. Pat. No. 6,092,847 to Kwan, U.S. Pat. No. 5,199,756 to Bartlett et al. and U.S. Pat. No. 2,864,645 to Meldrum.

However, none of these prior art devices serves well as a simple, easy-to-use device to be used by people who wish to grasp a wide variety of items such as door handles, toilet seats, etc. Each of them is either too large, too unwieldy, or ineffective to grasp a variety of items. What has not yet been suggested, and what is currently desired by people hoping to avoid contamination by germs on items likely to be touched by members of the public, is a grasping device which might be conveniently carried in one's pocket, and which can be releasably locked into a closed position.

Moreover, what is desired is an improved grasping device which has along its inner faces a resilient gripping material which can conform somewhat to the shape of the surface of an item being grasped when the device is in use, and which can also serve to trap germs in the device when the device is in a closed position (when, for example, the device is in the user's pocket or purse). What is also desirable is that the device be lockable into a closed position, and unlockable into an open position, with locking means which are preferably operable with one hand.

### SUMMARY OF INVENTION

The present invention is a device for grasping items which might be contaminated by germs. In the most basic embodiment of the invention, locking tongs are provided with resilient gripping material being provided on the interior surface of at least one arm of the tongs. In particular, the device has, in one embodiment, a lower arm having an upper face, a first end and a second end; an upper arm having a lower face, a first end and a second end, the second end of the upper arm attached to the second end of the lower arm; means for urging the first ends of the upper and lower arms apart from one another, thereby urging the device into an open position; and means for releasably locking the device into a closed position wherein the first ends of the upper and lower arms are nearer one another than in the open position.

In this device, at least one of the upper face of the lower arm and the lower face of the upper arm bears resilient gripping material along a portion of its length, and when the device is in the closed position, this resilient gripping material is compressed, thereby trapping in the device whatever germs might have been transferred to the material from the item being handled.

In the preferred embodiment of the device, the second ends of the arms are pivotally hinged to one another, although the arms can also be formed from one sheet of material bent over on itself, in which case the means for urging the first ends apart comprises the natural elasticity of the material. However, in the embodiment in which the arms are hinged together, the means for urging the first ends apart comprises a spring bearing on the upper face and on the lower face. The spring may be coiled around a pivot pin which hinges the two arms.

One or preferably both of the arms may bear the resilient gripping material.

In respect of the locking means, there may be provided a member grippable by a user's thumb, the member attached to one arm, preferably the upper arm, and having formed thereon a tab which is insertable into either a slot formed in the first end of the lower arm, in one embodiment, or into a notch formed in the second end of the lower arm in another embodiment. The member is movable between a first, locked position and a second, unlocked position. To aid a user in manipulating the device generally, and especially between a locked and unlocked position, the lower arm may be provided with a protrusion which the user may bear against with a finger.

The gripping material may have a smooth surface, or, preferably, will have undulations or grooves or the like, and in this case the material may be preferably arranged on the upper and lower arms such that the undulations interdigitate when the device is in a closed position.

### BRIEF DESCRIPTION OF DRAWINGS

It will be appreciated that the particularized description of the invention described briefly above and which follows hereafter is rendered by reference to certain specific embodiments of the invention which are illustrated in the appended drawings. The drawings depict only a few typical embodiments of the invention and are not therefore to be considered to be limiting of its scope.

Accordingly, in the accompanying drawings which illustrate specific embodiments of the invention, but which should not be construed as restricting the spirit or scope of the invention in any way:

FIG. 1 is a perspective view of one embodiment of a grasping device of the present invention, fixed in a closed position.

FIG. 2 is a perspective view of the grasping device shown in FIG. 1, but in an open position.

FIG. 3 is a side plan view of an alternate embodiment of the grasping device of the present invention, fixed in a closed position.

FIG. 4 is a top plan view of another alternate embodiment of the grasping device of the present invention.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Referring first to FIG. 1, the grasping device of the preferred embodiment of the present invention may be constructed generally of two arms, a lower arm 10 and an upper arm 20. Lower and upper arms 10, 20 may be formed of one piece of material folded over onto itself, or, as shown in the figures, may preferably be separate pieces which are hinged together.

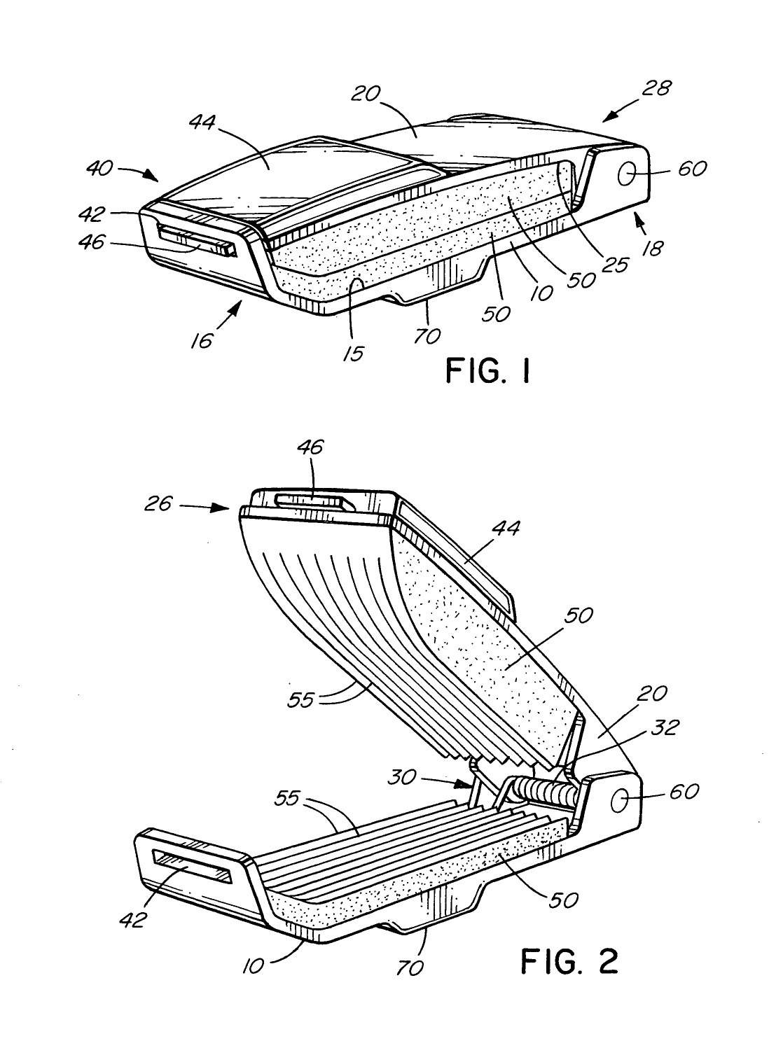

As shown in FIGS. 1 and 2, the lower arm 10 has a first (or front) end 16, and a second (rear) end 18. Similarly, the upper arm 20 has a first end 26 and second end 28. As illustrated, in the device of the preferred embodiment the arms 10, 20 are pivotally hinged together at their second ends 18, 28, by pivot pin 60. The first ends 16, 26 of arms 10, 20 are accordingly generally free to move from a position in which they are near one another (FIG. 1), when the device is in a closed position, and a position in which they are farther apart from one another, when the device is in an open position (FIG. 2).

The arms 10, 20 of the device each have an inner face. In the case of the lower arm 10, this is the lower arm's upper face 15. Upper arm 20 likewise has lower face 25. At least one of upper face 15 of lower arm 10 and lower face 25 of upper arm 20 bears a strip of resilient gripping material 50 along at least a portion of its length. Resilient gripping material 50 may be any suitable compressible material which can conform somewhat to the shape of an item being handled, and which provides good gripping friction when the device is in use, but is preferably a rubber material such as neoprene.

One important aspect of the invention is that material 50 provided on one or both of arms 10, 20 should be thick enough that when the device is in a closed position (FIG. 2), the material 50 is at least slightly compressed. In other words, it is important that any germs which may be transferred to the face of material 50 from an item being handled by a user of the device be held onto the face of the material 50, thereby lessening the chance that germs could escape from the device until it is cleaned. It will be appreciated that material 50, if applied only to one of faces 15 and 25, will need to be thicker than if applied to both of faces 15 and 25. If applied only to one of faces 15, 25, then the material 50 will hold germs between itself and the opposite face (15 or 25). If applied to both of faces 15, 25, then the two strips of material 50 will seal germs between their respective surfaces.

As previously described, hinged arms 10, 20 generally pivot about pivot pin 60 between a closed position and an open position. In the preferred embodiment of the invention, means 30 are provided for normally urging the first ends 16, 26 apart, forcing the device, when unlocked, into the open position. In the version of the device shown in the drawings (esp. in FIG. 2), this urging means is a spring 32 which is coiled around pin 60 and which has arms which bear force against both of faces 25 and 15. It should be clear that many other such means to urge apart the arms might be contemplated by those skilled in the art; such other devices are also contemplated by the inventor but not described herein in detail to avoid obscuring the invention.

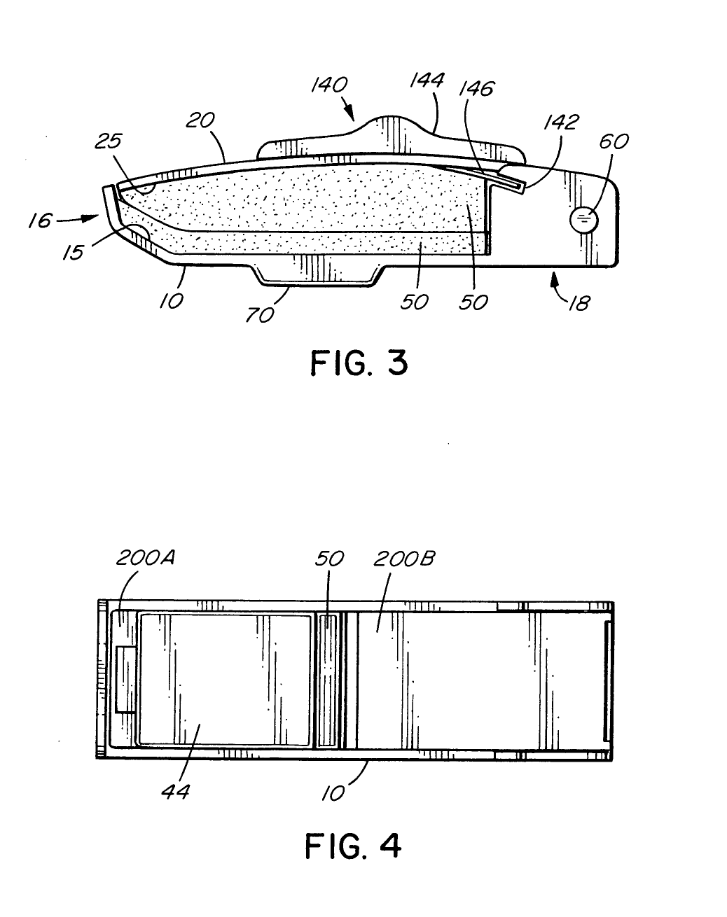

When the device has means for urging it into an open position, it also is provided with means for releasably locking the device into the closed position. FIGS. 1 and 3 show alternate embodiments of the invention, each bearing different locking means. It should be clearly described now that the inventor contemplates that a person skilled in the art would know that there exist various mechanisms for locking a device such as the present one in a closed position. These include: a captured pin and aperture member as described in U.S. Pat. No. 6,092,847 to Kwan; a channel shaped slidable locking member as described in U.S. Pat. No. 6,089,631 to Thurlow et al.; a slidable bow spring member as described in U.S. Pat. No. 6,056,338 to Kerr, a slidable locking plate as described in U.S. Pat. No. 5,199,756 to Bartlett et al.; a rivet sliding in a slot and notch as described in U.S. Pat. No. 2,864,645 to Meldrum; a latch member and pin as described in U.S. Pat. No. 2,800,356 to Benton, a toothed rack, spring and slot as described in U.S. Pat. No. 2,263,965 to Fiori; a clip for supporting an operating cam as described in U.S. Pat. No. 1,049,259 to O'Connor; and a pivotally mounted keeper as described in U.S. Pat. No. 772,566 to Hollowell. The applicant illustrates only two potential locking means to avoid unnecessarily obfuscating the description of the invention.

In one embodiment of the invention (FIG. 1), locking means 40 comprises a member 44 grippable by a user's thumb, which is attached to one of arms 10, 20 (in this case, arm 20) in a captured arrangement which allows member 44 to be slid by a user's thumb along the top face of arm 20 between a first, closed position, and a second, open position. In the closed position, a tab 46 formed on the end of member 44 is inserted into slot 42 formed in first end 16 of arm 10, thereby preventing spring 32 from forcing arms 10, 20 apart. In the open position (FIG. 2), member 44 is moved rearwardly (toward ends 18 and 28), causing tab 46 to be withdrawn from slot 42, allowing arms 10, 20 to be forced apart.

In an alternate embodiment (FIG. 3), locking means 140 comprises a member 144 grippable by a user's thumb, which is attached to one of arms 10, 20 (again in this case, arm 20) in a captured arrangement which allows member 144 to be slid by a user's thumb along the top face of arm 20 between a first, closed position, and a second, open position. In the closed position, a tab 146 formed on the bottom of member 144 and extending through arm 20 is inserted into a notch 142 formed in a side flange formed on the second end 18 of lower arm 10. It will be appreciated that tab 146 can extend the width of the device, in which case another notch (not shown) may be provided in a flange on the other side of the second end 18 of arm 10. When tab 146 is contained within notch 142, spring 32 is prevented from forcing arms 10, 20 apart. In an open position (not shown), member 144 is moved forwardly (toward ends 16 and 26), causing tab 146 to be withdrawn from notch 142, allowing arms 10, 20 to be forced apart by spring 32.

To aid in the manipulation by one hand of locking means 40 or 140, the bottom arm 10 may be provided with a protrusion 70 formed on the bottom surface thereof, and a user may bear against this protrusion with a finger to assist in the movement of locking means 40 or 140.

As shown in the figures, it will be appreciated that arms 10, 20 do not require a particular shape. They may be straight or curved, or have curved sections. In the embodiments of the invention shown in the figures, lower arm 10 has a curved front potion which overlaps the end of arm 20 when the devices in the closed position (seen best in FIG. 3). This upward curving of the end of arm 20 (and overlapping of the end of material 50 on arm 20) allows arm 10 to further seal in the device germs which might otherwise escape through the front of the device. The curved nature of arm 10 also presents to the user somewhat of a “hook” with which to ease manipulation of a device. Although not illustrated, it is foreseen that sides could also be provided to the device, the device then having an open position in which the material 50 was free of the sides and able to grip an item desired to be handled, and a closed position wherein the side portions of material 50 were enclosed, limiting further the opportunity for germs captured within the device to escape.

In a preferred embodiment of the invention, material 50 has formed on its surfaces undulations or grooves or the like, and in this case the respective strips of material may be preferably arranged on the upper and lower arms to face each other such that the undulations interdigitate when the device is in a closed position.

It will be appreciated that the arms 10, 20, need not be made of any particular material, but that they be constructed of a light material strong enough to withstand the forces applied to it. The inventor foresees, in a preferred embodiment of the invention, arms 10, 20 being constructed of aluminum or a plastic.

As will be apparent to those skilled in the art in the light of the foregoing disclosure, many alterations and modifications are possible in the practice of this invention without departing from the spirit or scope thereof. For example, while the invention has been described as having a hinge between the lower and upper arms, the arms need not be hinged together for the invention to work. In fact, the arms need not even each be a single piece as previously described. As shown in FIG. 4, either one or both of the arms may be broken into two or more portions (shown as 200A and 200B in FIG. 4), with each section connected to an adjacent section by material 50 which bridges the sections 200A and 200B. It is foreseen that this arrangement may lend more flexibility to arms 10, 20, which may be desirable if it is desired to handle larger items with the device.

What is important to the invention is that a light, small, portable, releasably lockable device be provided which has a resilient gripping material contained therein which material can trap germs transferred to it when the device is used to grip an item, and that the device be lockable and unlockable easily with one hand.

Accordingly, the scope of the invention is to be construed in accordance with the substance defined by the following claims.

1. A grasping device comprising:
(a) a lower arm having an upper face, a first end and a second end;
(b) an upper arm having a lower face, a first end and a second end, said second end of said upper arm attached to said second end of said lower arm;
(c) means for urging said first ends of said upper and lower arms apart from one another, thereby urging said device into an open position; and
(d) means for releasably locking said device into a closed position wherein said first ends of said upper and lower arms are nearer one another than in said open position;
wherein at least one of said upper face of said lower arm and said lower face of said upper arm bears resilient gripping material along a portion of its length, and wherein said resilient gripping material is compressed when said device is in said closed position.

2. The grasping device as claimed in claim 1 wherein said second ends are pivotally hinged to one another.

3. The grasping device as claimed in claim 2 wherein said means for urging said first ends apart comprises a spring bearing on said upper face and on said lower face.

4. The grasping device as claimed in claim 1 wherein both said upper face and said lower face bear said resilient gripping material.

5. The grasping device as claimed in claim 1 wherein said means for locking said device comprises a slot formed in said first end of said lower arm, and a tab formed on a member attached to said upper arm, said member movable relative said upper arm between a first position wherein said tab is inserted into said slot, and a second position wherein said tab is freed from said slot.

6. The grasping device as claimed in claim 1 wherein said means for locking said device comprises a notch formed in said second end of said lower arm, and a tab formed on a member attached to said upper arm, said member movable relative said upper arm between a first position wherein said tab is inserted into said notch, and a second position wherein said tab is freed from said notch.

7. The grasping device as claimed in claim 3 wherein said second ends are hinged by a pivot pin and wherein said spring is coiled around said pin.

8. The grasping device as claimed in claim 1 wherein said first end of said lower arm curves upwardly relative said upper arm.

9. The grasping device as claimed in claim 8 wherein said resilient material is enclosed at its ends by said upper and lower arms.

10. The grasping device as claimed in any one of the preceding claims wherein said upper arm has downwardly extending side members to enclose the sides of said resilient gripping material when said device is in a closed position.

11. The grasping device as claimed in claim 1 wherein said upper arm further comprises a first portion and a second portion, said first and second portions separated from one another but bridged on their lower faces by said resilient gripping material.

12. The grasping device as claimed in claim 1 wherein said lower arm further comprises a first portion and a second portion, said first and second portions separated from one another but bridged on their upper faces by said resilient gripping material.

13. The grasping device as claimed in claim 1 wherein both of said upper arm and said lower arm further comprise a first portion and a second portion, said first and second portions separated from one another but bridged by said resilient gripping material.

14. The gripping device of as claimed in claim 4 wherein said gripping material on said lower arm and said gripping material on said upper arm have undulations which may be interdigitated with one another when said device is in a closed position.

15. The gripping device of claim 1 where said lower arm has a lower face and a protrusion extending downwardly from said lowerface.

16. The grasping device as claimed in claim 2 wherein said upper and lower arms are formed from one sheet of material bent over on itself, and said means for urging said first ends apart comprises the natural elasticity of said material.

17. The grasping device as claimed in claim 1 wherein said gripping material is neoprene.
